(19) United States
(12) Patent Application Publication
(10) Pub. No.: US 2011/0036946 A1
(43) Pub. Date: Feb. 17, 2011

(54) AIRCRAFT FLOOR MODULE, STRUCTURE AND METHOD FOR ATTACHING SUCH A MODULE AND AIRCRAFT COMPRISING THEM

(75) Inventors: Alain Depeige, Tournefeuille (FR); Christian Rivaud, Toulouse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: AIRBUS OPERATIONS (inc. as a Soc.par Act.Simpl.), Toulouse (FR)

(21) Appl. No.: 12/989,965

(22) PCT Filed: Apr. 29, 2009
(86) PCT No.: PCT/FR2009/000508

§ 371 Date: Oct. 28, 2010

(30) Foreign Application Priority Data
Apr. 29, 2008 (FR) 0852896

(51) Int. Cl. B64C 1/18

(52) U.S. Cl. 244/120

(57) ABSTRACT

A method of fitting-out of an aircraft by laying of a floor, particularly in a cockpit of an aircraft, and such a fitted-out aircraft. The aircraft includes a fuselage part defining an interior volume and at least one internal on-board structure, the on-board structure being secured to the fuselage part and configured to accept a floor module. The method then involves introducing the floor module into the volume and attaching the floor module to the on-board structure.

The present invention relates to outfitting an aircraft by laying a floor, particularly in the cockpit of an aircraft. The invention relates more particularly to a method for outfitting an aircraft and to such an aircraft.

Traditionally, the floors of the cabin or cockpit of an aircraft are directly integrated into the structure constituting its fuselage during construction thereof, especially the front fuselage for the cockpit floor. Examples of integration of these floors are provided in patent documents FR2689851, FR2872780, FR2872781, FR2872782 and FR2900125.

In practice, crosspieces for forming a floor structure are progressively fixed to the frames as construction of the fuselage advances. Longitudinal beams or longerons ensuring the stability of these crosspieces and the transmission of longitudinal forces, especially in the case of a forced landing, are then guided in and fixed to the crosspieces. The assembly of these crosspieces and longerons forms the floor structure, which can then be covered with finishing elements such as stiffening membranes that encompass both the crosspieces and certain longitudinal membranes to form box or semi-box structures. Demountable panels and plates for underpinning seats are then set down on the structure.

In Application FR2872782, the floor structure is intended to be fixed directly on the frames of the fuselage, by superposition of the frame with the ends of the crosspieces. Thus the crosspieces are broader than the distance separating the opposite parts of a given frame, thus preventing easy manipulation of the floor structure in the interior of the fuselage.

In the case of the A380 (trade name), the procedure is slightly different, in that construction of the fuselage begins from an already assembled structural module of a floor, for example of the cockpit. The fuselage is therefore mounted progressively all around this module.

Traditionally, the floors are generally mounted substantially at mid-height of the fuselage, slightly below the horizontal diametral plane of the fuselage.

These floors or floor structures may constitute a difficulty as regards construction of the rest of the fuselage, for example by preventing the introduction of bulky implements into the body of the aircraft under construction.

The goal of the invention is to alleviate one of the disadvantages of the prior art.

To this end, the invention relates in particular to a method for outfitting an aircraft comprising a fuselage part formed from at least frames and horizontal stringers and defining an interior space of the said aircraft and comprising at least one internal on-board structure, the said on-board structure being made integral with the said fuselage part and being adapted to receive a floor module, the method comprising a step of introducing the floor module in the interior of the said space and a step of fixing the floor module to the said on-board structure.

The floor module may be reduced to a simple structure devoid of covering.

By virtue of the invention, the on-board structure constitutes available fixation means for receiving a floor to be fixed. Consequently it is possible to undertake integration of the floor module at any time during the fuselage design process, especially after advanced establishment of the local fuselage provided around the floor and its parts. The invention therefore makes it possible to simplify the mechanism for construction and assembly of aircraft.

In addition, this on-board structure supplementing the fuselage makes it possible to reduce the width of the floor module to be inserted. Thus the ratio between the dimension of the floor module and the interior space in the fuselage is reduced for better manipulation of the floor in the interior of the space, for example during its insertion.

For the invention, “fuselage” is understood as a basic structure of the hull of an aircraft, defining an interior space of that aircraft. This structure may be of minimalist composition made from frames and/or stringers and/or panels constituting a skin. The space defined in this way does not necessarily correspond to the total space of the finished aircraft, but may represent only a section, especially that in which the floor module according to the invention is integrated.

In general, the structures of such prior art floors assume the shape of fuselages of the aircraft. By taking into account different shapes of the nose cone from one aircraft to the other, these floors are then different for each aircraft, even though the rules of ergonomics governing the positioning of the crew members and their environment (such as apparatus, seat, rudder pedal) do not vary greatly. For example, the lateral distance between two pilots side-by-side must permit simultaneous access of both crew members to the fuel controls of the engines as well as to certain controls of movable surfaces (slats, flaps, compensators, air deflectors, etc.). Similarly, the distance from the pilot's eye to the on-board instrument panel, the inclination of this panel, the position of the main flying controls, sidestick and rudder/brake pedals are derived from ergonomics standards encompassing a range of pilot heights (generally from 1.57 m to 1.95 m).

In this context, the invention allows a given floor module constituting the desired “invariant” central zone to be used easily for different aircraft. The invention is just as applicable for a cockpit providing traditional placements of pilot seats and instruments as for a cabin floor that may be pre-equipped with rails having constant geometry from one aircraft to the other and/or with systems and cables.

It is then provided that the said floor module has predefined dimensions and the said on-board structure is dimensioned in such a way as to occupy the space left free between the said fuselage part and the floor module in its fixation position. By mutualizing these modules for diverse types of aircraft, the costs of development and tooling for integration and maintenance of floors in an aircraft are reduced.

In one embodiment, the said floor module and the on-board structure are configured so as to form a substantially plane upper surface when in fixation position. In this way the usable surface, meaning the surface on the floor, either in the cockpit or in the cabin, is optimized. It is then noted that the on-board structure is intended to occupy the free space left between the provided floor module and the fuselage. In this case, fixation means provided in the thickness of the floor module and in the corresponding thickness of the on-board structure are envisioned.

Several modes of introduction of the floor module into the aircraft may be envisioned.

In one of them, the floor module is introduced horizontally by translation in such a way as to guide at least one fixation means provided on the floor module straight above a corresponding fixation means provided on the on-board structure, then the floor module is displaced along the vertical axis in such a way that the said fixation means are made to cooperate. The translational movement may be achieved in particular in the longitudinal direction of the aircraft, for example from the rear of the aircraft, where the fuselage will not yet have been closed or finished. In particular, since the on-board structure is slightly below the horizontal diametral plane of the fuselage, the floor module is introduced above the on-board structure, substantially at the level of the said mid-height, where the fuselage is broadest.

This mode of introduction is favored when the fixation means jut out, either on the floor module or on the on-board structure, in such a way that it is not conceivable to slide the floor module directly by translation at the same height (or in other words in the same plane) as the on-board structure.

One example of such fixation means comprises a fork end with eyes.

In particular, it is provided that the said fixation means provided on the floor module comprises a fork-end fitting disposed in the interior of a crosspiece forming a structure of the module, at the end of the said crosspiece, and the said fixation means provided on the on-board structure comprises a fork-end fitting capable of cooperating with the said fork end of the floor structure. In practice, a female fork end or fork ends with eyes is or are used on one side and a male fork end or fork ends with eyes on the other side, cooperating by tightly secured mounting of bushes or stays. The displacement of the floor module along the vertical axis therefore makes it possible to engage one fork end in the other, even though these are positioned vertically in order to absorb the forces along the longitudinal axis of the aircraft.

Alternatively, the fork ends may be integrated directly in the structure of the floor module.

It is noted that such fork-end fixation means may be used in combination with other mechanisms for introduction of the module into the aircraft.

In particular, it is provided that the said fittings comprise two fork ends that are symmetric relative to a median plane of symmetry of the fittings. By virtue of these arrangements, these fittings may be used equally well on a starboard part as on a port part of the floor structure and/or of the on-board structure. The corresponding development costs are therefore reduced. In addition, the twin fork ends constitute more effective fixation means.

To permit tolerance in the manufacture of the on-board structure and of the floor module without preventing fixation of one to the other, it is provided that, for two fork ends intended to cooperate together, one has an eye of oblong shape. In this way a case of offset of the fork ends during mounting is resolved. In the case of twin fork ends, it is provided that the two assemblies of fork ends intended to cooperate together to fix the floor module each have an eye of oblong shape, one along a horizontal axis and the other along a vertical axis. In this way eccentricity along all the directions of the plane of the fork ends is compensated for.

According to another mode of introduction, it is provided that the floor module is introduced by translation, typically along the longitudinal axis of the aircraft, in inclined position around the longitudinal axis of the aircraft and therefore relative to the horizontal plane, in such a way as to guide at least one fixation means provided on the floor module at the same height, along the longitudinal axis of the fuselage part, as a corresponding fixation means provided on the on-board structure, then the floor module is turned around the longitudinal axis in such a way that it is made to cooperate with the said fixation means.

This configuration makes it possible to introduce the floor module efficiently into the aircraft even though elements, for example related to the presence of already mounted equipment items or structures, present an obstacle to horizontal insertion of the module.

A traditional inclination for introduction is on the order of 45°. Fixation can be achieved, for example, by screwing and bolting the on-board and floor-module structures together. Fork ends such as described in the foregoing may also be used for this other mode.

In order to optimize the process of mounting of aircraft even more, it is possible to envision assembly of an already pre-equipped floor module. Thus it is provided that the said floor module comprises a floor structure covered with a floor lining on its upper surface and with underpinnings for equipment items, such as seats, rudder/braking pedal blocks or a central control pedestal.

The invention also relates to an aircraft comprising a fuselage part defining an interior space of the said aircraft and comprising at least one internal on-board structure, the said on-board structure being integral with the said fuselage part, in which aircraft the said on-board structure comprises free fixation means capable of receiving corresponding fixation means of a floor module in such a way as to fix the latter to the said fuselage part. Such an aircraft is then ready to receive a floor module, for example according to the mechanisms alluded to hereinabove.

By “free fixation means” there are understood here fixation means devoid of fixed elements. These fixation means are therefore unused at this stage and are “available” to receive corresponding means of a third element in order to bring about fixation of this third element to the fuselage part.

In one embodiment, the said aircraft comprises a frame having a window zone resting on the said on-board structure.

In one embodiment, it is provided that the said aircraft comprises a means of compensation for longitudinal forces (forces in X direction) undergone by the said aircraft, for example in case of a forced landing, the said compensation means connecting the said on-board structure to an element of the fuselage part, such as a frame element. By way of example, tension or compression connecting rods or shackles, also known as “crash absorbers”, may be provided for this purpose. These shackles or connecting rods absorb a large part of the shocks and forces resulting in this case from the forced landing.

In one embodiment, the on-board structure comprises a horizontal fitting supporting a fixation means, an upper web and a lower web, both integral with the said fitting, in such a way as to form a box member. In this way the simple fitting is reinforced against shear.

Alternatively, the on-board structure comprises a horizontal fitting supporting a fixation means, a single upper web integral with the said fixation means in such a way as to form a semi-box edge structure.

Regardless of the alternative, the fitting may be furnished with a free end of a twin fork end with eyes acting as fixation means, the other end generally being fixed to the fuselage.

In these two alternatives, it is possible to provide that the said webs comprise apertures. These apertures make it possible in particular to pass cables through or to achieve ventilation.

Optionally, the said aircraft may comprise means relating to the method-specific characteristics presented hereinabove.

Other features and advantages of the invention will become more apparent in the description hereinafter, illustrated by the attached drawings, wherein:

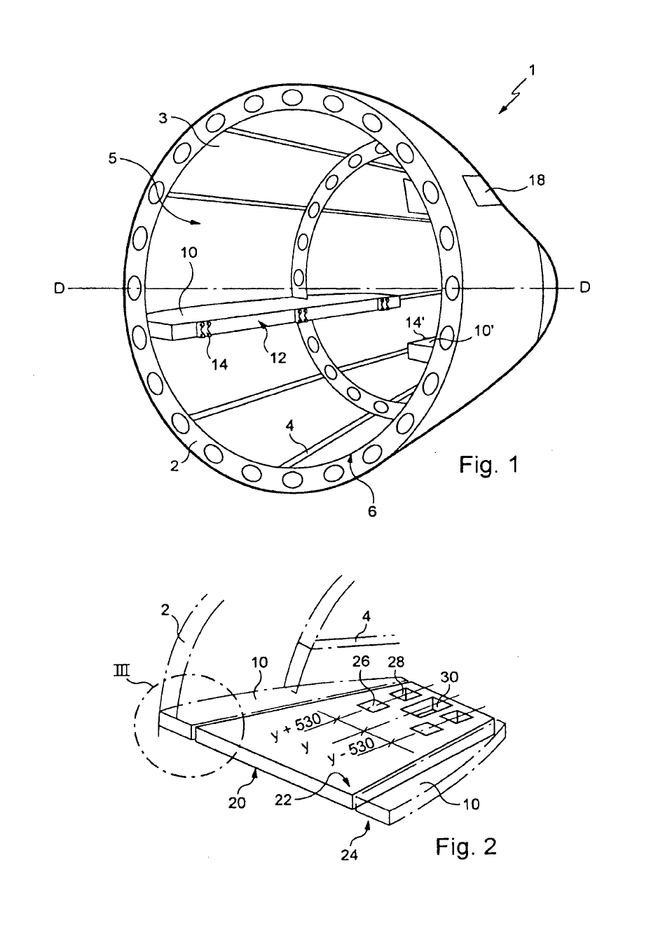

FIG. 1 represents an aircraft structure capable of receiving a modular floor according to the invention;

FIG. 2 is an interior view of the same aircraft structure equipped with a modular floor installed according to the invention;

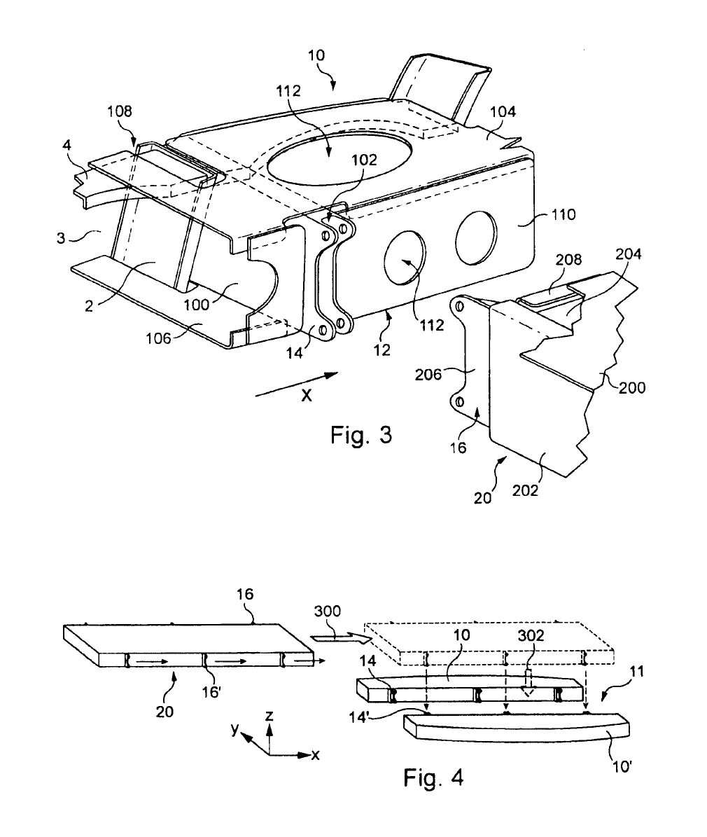

FIG. 3 represents a detail of FIG. 2 showing an example of fixation of the modular floor to the aircraft structure;

FIG. 4 illustrates a first example of installation of the said modular floor of FIG. 2;

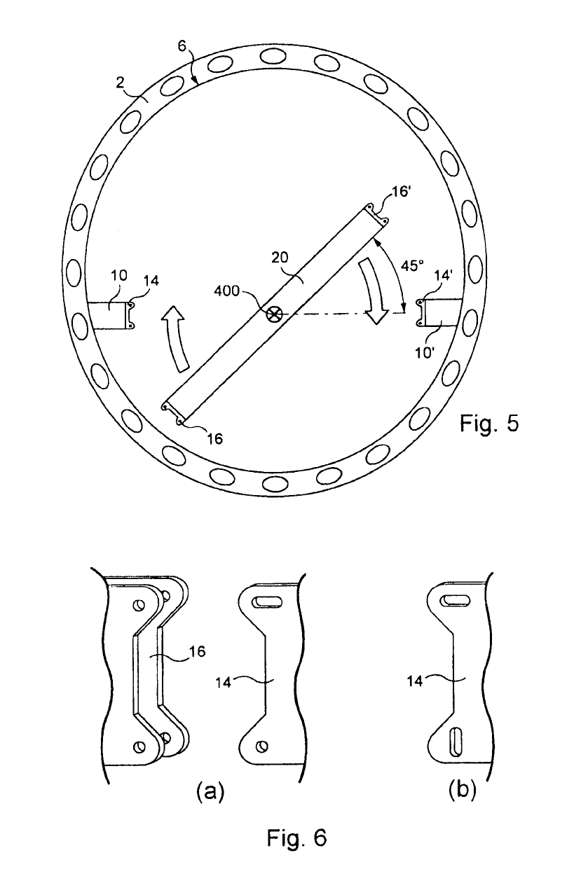

FIG. 5 illustrates a second example of installation of the said modular floor of FIG. 2; and

FIG. 6 is a detail of the means of fixation of the floor to the aircraft structure.

The present invention relates to the outfitting of an aircraft in the course of construction by means of a modular floor, in general pre-equipped.

FIG. 1 represents an aircraft, in the present case an airplane, in the course of construction, wherein there is distinguished a front part 1 corresponding to the nose of the aircraft, which front part 1 will be made integral with the rest of the aircraft in a later step of construction.

This front part 1 comprises a reinforcement formed of elements of frame 2 that substantially define the section of the airplane at their positions, this reinforcement being covered by a skin 3 in such a way as to form a part of the fuselage of the aircraft. Horizontal stringers 4 stiffening the said fuselage are also provided between the elements of frame 2.

This front fuselage part 1 therefore forms an internal space 5 of the aircraft, in the present case the cockpit space, whose aperture 6 is roughly circular or oval.

Front part 1 also comprises, in a horizontal plane slightly below the horizontal diametral plane D-D (in other words along a horizontal chord under the diameter), edge box members 10, 10′, two in this case, disposed on each side of the fuselage in its interior. These box members 10 therefore extend from the lateral wall of the fuselage toward the interior of the space defined by it, over only part of the horizontal chord.

These edge box members 10, 10′ are made integral with frames 2, stringers 4 and skin 3 of the fuselage by traditional means, such as adhesive bonding, welding and/or riveting. They assume the shape of the fuselage on one side and are rectilinear, for example, on the other side.

On the rectilinear side face 12 of these edge box members 10, 10′, there are provided a plurality of fixation means 14, 14′, in this case twin fork ends in vertical position, having two lugs provided with an eye in the upper and lower parts. These twin fork ends with eyes are capable of receiving complementary fixation means 16, 16′.

Alternatively, it would be possible to provide a plurality of box members on each side of the aircraft, each supporting one fixation means 14.

The two edge box members 10, 10′ therefore define, in their common plane, a zone 11, in which a movable floor module 20 can be inserted and fixed, as described hereinafter.

In the absence of such a module 20, fixation means 14, 14′ are free, and nose 1 of the aircraft has an empty internal space 5 favorable for internal outfitting without difficulties.

FIG. 2 shows interior front part 1 of the aircraft, in this case equipped with a cockpit floor module 20 formed substantially of one structure. In this configuration, the upper surfaces of lateral box members 10 and of floor module 20 are coplanar, in such a way as to define floor 22 of the cockpit of the aircraft in the entire width of the fuselage.

The thicknesses of lateral box members 10 and of floor module 20 are substantially equal here. Thus lower surface 24 of the assembly forms a regular boundary for a storage space to be outfitted.

Floor module 20 may be pre-equipped before it is installed in nose 1 of the aircraft. In fact, it is easier to achieve integration of equipment items on the floor outside the fuselage of the aircraft, rather than in the restricted space defined by it.

In the example of FIG. 2, floor module 20 comprises equipment items 26 for underpinning seats, which items respect the integration standards (in this case ±530 mm on both sides of the central axis), rudder/braking pedal blocks 28 and central control pedestal 30.

Referring now to FIG. 3, an example of edge box member 10 and of floor module structure 20 are described, as are the elements assuring fixation of one to the other.

Edge box member 10 has a structure comprising a plurality of fittings 100 that extend from the fuselage toward the interior of the aircraft and are fixed to the fuselage of the aircraft, all in the same horizontal plane. In the present case, fitting 100 is fixed both to a frame element 2 and to a longeron or stringer 4 of the fuselage.

Fitting 100 is provided in forged and remachined light alloy. It is cut to length on the side of covering 3 in such a way that the distance between its end 102 and the end of a corresponding fitting 102′ provided on opposite edge box member 102′ corresponds substantially to the width of modular floor 20 to be installed in the same plane.

Ends 102, 102′ of fittings 100, 100′ terminate in twin female fork ends with eyes 14, 14′, as represented in FIG. 2.

Fittings that are symmetric relative to their horizontal median plane as well as the cutting of fittings 100, 100′ to length make it possible to use the same type of fitting for box members 10, 10′ of both sides of the aircraft.

In the present case, each box member 10 is formed from two substantially horizontal metal webs 104 and 106 disposed respectively on and under the structure of box member 10 formed by the plurality of fittings 100. In particular, upper web 104 is fixed to a stringer 4 and to the different fittings 100 of this side of the fuselage. Appropriate slots 108 are provided to assume the shape of frames 2. Lower web 106 is fixed solely to fittings 100. These webs 104 and 106 reinforce the resistance of box member 10 to forces of shear type.

Side face 12 of box member 10 is formed by one or more substantially vertical plates 110 fixed on lips of the two webs 104 and 106, these lips being bent over at 90°.

Webs 104, 106 and plate 110 are provided with apertures 112 that permit cables or tubes to be passed through and that prevent a pressure difference between the interior of box member 10 and the cockpit.

In the case of FIGS. 2 and 3, edge box members 10, 10′ are provided in the cockpit of the aircraft. The two box members 10 and 10′ provide support for the frames of window zone 18 in order to compensate for the interruption of frames 2 of the fuselage caused by the presence of windows 18.

In particular, the frames of the window zone are embedded by mechanical fixations on crosspieces or fittings of the floor box member and are semi-embedded, also by mechanical fixations (bolts or rivets, for example) under the horizontal molding running along the lower edge of the windows and providing local support for these.

To relieve box member 10 of large forces in longitudinal axis X of the aircraft, for example in the case of a forced landing, there are provided tension or compression connecting rods or shackles, also known as “crash absorbers”, connecting box member 10 to the fuselage, for example to a frame 2 or to a stringer 4.

Floor module 20 of the front flight deck (or cockpit) has predefined dimension. As indicated hereinabove, the dimensions of edge box members 10, 10′ are adapted to the dimensions of floor module 20. This may be achieved by increasing or decreasing the length of fitting 100 and by correspondingly adapting webs 104 and 106 as well as plate 110. Preferably, the two fittings 100 facing one another in box members 10 and 10′ have the same length, in such a way that they permit centering of floor module 20 in the corresponding horizontal plane.

Floor 20 may therefore be used in standard manner on a number of aircraft of different types around an invariant “system” comprising, for example, seat underpinnings 26, rudder/braking pedal blocks 28 and central control pedestal 30.

Floor module 20 has a composite structure formed from a framework of crosspieces 202 and longerons 204, for example of all carbon, thermoplastic or thermosetting plastic nature, with some metal fittings for structural binding or with system supports. In the present case the structure is covered by a floor panel 200 fixed thereto and is closed along the side face by metal plates 208.

Floor module 20 also comprises fittings 206 with twin male fork ends 16, 16′ of minimally remachined forged light alloy, that is to say that the as-forged blanks of fork ends 16, 16′ are machined only at right angles to the surfaces coming into contact or facing other parts (fork ends 14, 14′), in order to minimize the machining operations and the risks of twisting of parts during these operations. Fittings 206 are placed in the interior of crosspieces 202 at their end. It is noted here that crosspieces 202 and fittings 100, 100′ of edge box members 10, 10′ are provided to face one another (and therefore to be coplanar) in the final position in which floor module 20 is laid in the interior of the aircraft.

Twin male fork ends 16 and twin female fork ends 14 are provided to cooperate in such a way that they permit fixation of modular floor 20 on edge box member 10.

Fixation of the two elements can be achieved in particular by linking with shear pins having axial play and counterboring of fork ends 16 of floor module 20, using fork ends 14 of edge box member 10 as boring barrel support in such a way as to form the eyes of fork ends 16, the said barrels then being replaced by bushes or stays of the same thickness for tightly secured mounting on a single lug of each link.

Thus box member 10 absorbs part of the bending/torsional forces necessary for fixation and support of floor 20 underpinned by twin female fork ends 14.

Referring to FIG. 4, a first mode of installation of floor module 20 in the interior of aircraft 1 is presented.

Floor module 20, pre-equipped if necessary, is introduced in horizontal position via aperture 6 provided at the rear of the aircraft nose, by translation 300 along the longitudinal axis. This translation is carried out in a horizontal plane vertically offset relative to that of box members 10 and 10′. In fact, it is not possible to introduce floor 20 in the same plane as box members 10, 10′, because twin fork ends 14, 14′, 16, 16′ would collide with one another. The floor is positioned substantially in the alignment of side edges 12 of box members 10, 10′.

Insertion is preferably carried out with floor module 20 in a plane above box members 10′ substantially at the height of diametral plane D-D′, where the fuselage width is greatest, thus limiting the difficulty caused by possible obstacles.

By means of this translation 300 along the X axis, floor module 20 is guided above empty space 11 between box members 10, 10′ provided in particular with twin fork ends 14 (14′) facing twin fork ends 16 (16′).

A vertical displacement 302 along the Z axis is then carried out to guide floor module 20 into the same plane as box members 10, 10′. Twin fork ends 16, 16′ then engage in free twin fork ends 14, 14′ of the waiting box members. These are fixed together as alluded to in the foregoing, in such a way as to assure fixation of floor module 20 to box members 10, 10′.

The assembly formed in this way is covered with a floor lining 200 if necessary.

It is possible to envision different shapes for floor module 20 in the horizontal plane. In one example, a rectangular shape (the case of FIG. 4) is easy to construct. In this case, edges 12 of box members 10, 10′ are parallel.

Alternatively, floor module 20 may be of trapezoidal shape (FIG. 3), the shortest parallel side being, for example, the side opposite to aperture 6. In this alternative, the adopted shape corresponds in particular to the taper of nose 1 of the aircraft.

It will also be noted that such a shape may permit easier insertion into empty zone 11, since the available width at the aperture is broader than the part to be introduced first. Such insertion in a manner coplanar with box members 10, 10′ may be provided if fixation means 14, 16 are not projecting from box members 10 and from floor module 20.

FIG. 5 illustrates a second embodiment for installation of floor module 20 in interior 5 of aircraft 1.

Floor module 20, pre-equipped if necessary, is introduced by translation along longitudinal axis X of the aircraft, central axis 400 of the floor preferably being substantially at the height of box members 10, 10′ and in the middle of empty space 11 between the two.

During this translation, floor module 20 is inclined relative to the horizontal and around the longitudinal axis of the airplane, for example by an angle of 45°. In this way floor module 20 is translated to the height of box members 10, 10′, in such a way that corresponding twin fork ends 14-16 and 14′-16′ are at the same height along the horizontal axis, or in other words are in the same vertical plane (YZ) perpendicular to the longitudinal axis.

Floor module 20 is then rotated around axis 400 in order to position it in the horizontal, fork ends 16, 16′ engaging in corresponding fork ends 14, 14′.

Floor module 20 is then fixed to box members 10, 10′ by means of stays according to the mechanisms presented hereinabove.

FIG. 6 illustrates an improvement of fixation means 14, 14′, 16, 16′ in the form of twin fork ends. This improvement then permits a tolerance in dimensioning of fittings 100, 100′ and of relative planarity of box members 10 and 10′.

In FIG. 6a, it is provided that one of the eyes of twin fork ends 16, 16′ of floor 20 has oblong shape, either along the horizontal axis or along the vertical axis, depending on the type of defect to be corrected.

In FIG. 6b, both eyes of twin fork ends 16, 16′ have oblong shape, one along the horizontal axis and the other along the vertical axis, in order to ensure correction for tolerance in both directions.

The foregoing examples are merely some embodiments of the invention, which is not limited thereto.

In particular, a cockpit floor module 20 has been presented. However, a rear floor module adapted to the geometry of the aircraft is envisioned, edge box members 10, 10′ then retaining a reasonable overhang and being adapted to the rear structure of the aircraft in question. It is also possible to apply the mechanisms of the invention to a central floor module for passenger cabins.

Furthermore, fixation fork ends 14 or 16 may be set back from the respective edges or side faces 12, 208 of box member 10 and floor module 20. In this way the empty space between these two elements is minimized when they are fixed to one another.

Also, as an alternative to box members 10, it is possible to provide semi-box edge structures having a single upper web 104 or structures having a stiffening lattice.

As an alternative to floor module 20 of composite structure, it is also possible to provide a metal structure having the same general architecture of longerons and crosspieces.

1-10. (canceled)

11. A method for outfitting an aircraft including a fuselage part formed from frames and horizontal stringers and defining an interior space of the aircraft, and at least one internal on-board structure, the on-board structure being made integral with the fuselage part and being adapted to receive a floor module, the method comprising:
introducing the floor module in the interior space, the floor module having predefined dimensions;
fixing the floor module to the on-board structure; and
dimensioning the on-board structure so as to occupy space left free between the fuselage part and the floor module in its fixation position.

12. A method according to claim 11, wherein the floor module is introduced horizontally by translation so as to guide at least one fixation means provided on the floor module straight above a corresponding fixation means provided on the on-board structure, then the floor module is displaced along the vertical axis such that the fixation means are made to cooperate.

13. A method according to claim 11, wherein the floor module is introduced by translation in an inclined position around the longitudinal axis of the aircraft, so as to guide at least one fixation means provided on the floor module at a same height, along the longitudinal axis of the fuselage part, as a corresponding fixation means provided on the on-board structure, then the floor module is turned around the longitudinal axis such that the fixation means are made to cooperate.

14. A method according to claim 11, wherein the fixation means provided on the floor module comprises a fork-end fitting disposed in the interior of a crosspiece forming a structure of the module, at the end of the crosspiece, and the fixation means provided on the on-board structure comprises a fork-end fitting integral with the fuselage and capable of cooperating with the fork end of the floor structure.

15. A method according to claim 14, wherein the fittings comprise two fork ends symmetric relative to a median plane of symmetry of the fittings.

16. A method according to claim 11, wherein the floor module is of trapezoidal shape and the introducing is achieved by first introducing a shortest parallel side of the floor module into the interior space.

17. A method according to claim 11, wherein the floor module and the on-board structure are configured so as to form a substantially plane upper surface when in a fixation position.

18. A method according to claim 11, wherein the on-board structure comprises a horizontal fitting made integral with the fuselage and supporting a fixation means for receiving the floor module, and at least one upper web integral with the fitting so as to form an at least semi-box edge structure.

19. A method according to claim 18, wherein the at least one web comprises apertures, configured for passage of cables or providing ventilation.

20. A method according to claim 11, wherein the floor module comprises a floor structure covered with a floor lining on its upper surface and with underpinnings for equipment items.
